(19) United States
(12) Patent Application Publication
(10) Pub. No.: US 2022/0321996 A1
(43) Pub. Date: Oct. 6, 2022

(54) CONE ARRANGED SPEAKER

(71) Applicant: Nam Hae LEE, Seoul (KR)

(72) Inventor: Nam Hae LEE, Seoul (KR)

(21) Appl. No.: 17/707,949

(22) Filed: Mar. 29, 2022

(30) Foreign Application Priority Data
Apr. 5, 2021 (KR) 10-2021-0043802

(51) Int. Cl. H04R 1/34; H04R 1/02

(52) U.S. Cl. CPC H04R 1/345; H04R 1/02; H04R 2201/029

(57) ABSTRACT

Disclosed herein is a cone arranged speaker. The cone arranged speaker includes: a speaker unit; an enclosure accommodating the speaker unit in at least one surface and having an empty space therein; and a conical reflector formed as a cone inside the enclosure, provided to surface-reflect a sound wave propagating from the speaker unit, including a vertex, a circular planar portion, and a side surface portion connecting the vertex and the planar portion, and provided as at least one conical reflector.

### BACKGROUND

### 1. Field

The present disclosure relates to a cone arranged speaker, and more particularly, to a cone arranged speaker such that sound waves propagating from the speaker are reflected at various angles to an outer curved surface of a cone by arranging a cone structure inside a speaker enclosure.

### 2. Description of Related Art

In general, a speaker includes a speaker unit converting an electrical signal into an aerodynamic signal and an enclosure accommodating the speaker unit therein and performing a function of a sound reflection so that a sound produced by the speaker unit may be well expressed without distortion.

Such a speaker may be mainly classified into a sealed speaker and a duct-type speaker according to a type of enclosure. The sealed speaker supports the sound of the speaker unit through only the sound reflection inside the enclosure by having a structure in which an inner portion of an enclosure is completely sealed, while the duct-type speaker particularly improves characteristics of a low range by including a duct provided in an enclosure so as to be in communication with an inner portion of the enclosure to invert a phase of a sound wave generated from a rear face of a cone of a speaker unit and discharge the source wave whose phase is inverted to the outside of the enclosure.

As described above, the enclosure of the speaker does not simply serve as a case accommodating the speaker unit therein, but serves to reflect and attenuate a sound wave generated from the speaker unit, and thus, is a component as important as the speaker unit in the speaker.

The enclosure according to the related art is provided as simply a planar surface 1 or a concave curved surface 2 or a convex curved surface 3 as shown in FIG. 1A. Accordingly, when the sound wave propagating from a speaker unit 10 has a characteristic reflected path of sound according to a shape of each surface when reflected from each surface.

Referring to (a) of FIG. 1A, in the case of planar reflection, the diffusivity of a path of sound depends only on a radiation angle of the sound of the speaker unit, and the path of sound has no additional diffusivity. Referring to (b) of FIG. 1A, a concave surface has a path through which a reflected path of sound is once converged and then diffused, and, compared to a convex surface of (c) of FIG. 1A, the concave surface has a reflective characteristic in which the diffusivity of the path of sound deteriorates with respect to the path of sound of the same length and the path of sound is rather narrowed up to a predetermined length.

Referring to (c) of FIG. 1A, the convex surface has a reflection characteristic in which the path of sound is expanded from an initial reflection without a phenomenon in which the path of sound is narrowed and broadened.

FIG. 1B shows a three-dimensional path of sound of (a) of FIG. 1A. Referring to FIG. 1B, when a sound wave 11 propagating from the center of the speaker unit 10 is reflected from a plane 12, a reflected surface 13 may be confirmed. The reflected surface 13 has a very simple shape and a narrow area.

FIG. 1C shows a cylindrical shape included in existing technologies among the three-dimensional shape of (c) of FIG. 1A. Referring to FIG. 1C, when the sound wave 11 propagating from the center of the speaker unit 10 is reflected from a cylindrical curved surface 17, a reflected surface 18 may be confirmed. The reflected surface 18 is wider than the plane of FIG. 1B. However, there is a limitation in that the reflected surface 18 does not have the diversity of a changed reflection angle.

Comparing the structure of such a reflective surface, compared to the planar structure of (a) of FIG. 1A, the cylindrical structure between the concave reflective structure of (b) of FIG. 1A and the convex reflective type of FIG. 1C contributes to the diffusion of path of sound, but the concave reflective structure of (b) of FIG. 1A lacks diffusivity with respect to a convergence section of sound and the length of the path of sound, and there is a distinct limitation in that the convex reflective cylindrical structure of FIG. 1C does not have a variety of reflection angles of the reflected sound.

In order to obtain a more even reflection characteristic for each frequency of the reflected sound of the speaker enclosure, it is necessary to maximize the diffusivity of the path of sound and the variability, which is the reflection characteristic at various angles, by using a more improved method.

### SUMMARY

The present disclosure has been made in order to solve the demand and the necessity as described above, and an object of the present disclosure is to provide a cone arranged speaker that reflects sound waves propagating from a speaker unit on a conical reflector provided inside an enclosure, thereby inducing greater diffusivity and variability in a reflected path of sound, and variously disperses a sound inside the enclosure, thereby effectively suppressing resonance of a specific frequency and enhancing a sound quality.

According to an embodiment of the present disclosure, a cone arranged speaker includes: a speaker unit; an enclosure accommodating the speaker unit in at least one surface and having an empty space therein; and a conical reflector formed as a cone inside the enclosure, provided to surface-reflect a sound wave propagating from the speaker unit, including a vertex, a circular planar portion, and a side surface portion connecting the vertex and the planar portion, and provided as at least one conical reflector.

The conical reflector may be provided as a hollow open type or is provided as a solid inside so that the inside thereof is not used as an expansion space of a sound wave.

The conical reflector may be arranged on any one surface of the enclosure, or spaced apart from an inner surface of the enclosure without spanning any one surface and supported by a support to be provided inside the enclosure.

A line connecting the vertex of the conical reflector and the center of the planar portion may be arranged at an angle that does not correspond to a longitudinal direction of the enclosure.

The conical reflector may be provided as a semi-cone.

The conical reflector may be provided as a ¼ semi-cone, a ⅙ semi-cone, or a ⅛ semi-cone.

A part of the conical reflector may be truncated.

Central axes of conical reflectors may be provided not to be parallel to each other.

A part of any one of the conical reflectors may overlap with the other conical reflector of which a part is truncated.

The conical reflector may be provided in rows each including a plurality of sub-reflectors, and the sub-reflectors of each row may be arranged in a certain direction or are arranged in different directions.

Each conical reflector may be combined and formed with respect to a planar portion, and the combined conical reflector may have a structure in which a part thereof is cut or spaced apart from a wall surface of the enclosure.

The side surface portion may be provided to be convex or concave.

According to the present disclosure, a conical reflector is provided as a part of the enclosure so that sound waves arriving directly from the speaker unit or secondary and tertiary reflected arrival waves reflected from the wall surface of the enclosure are diffusely reflected at various angles regardless of the angle of entry of the sound, and thus the resonant frequency of the sound is suppressed and the sound quality of the speaker is enhanced.

### BRIEF DESCRIPTION OF DRAWINGS

FIG. 1A is a schematic diagram illustrating a reflection characteristic of a sound wave according to a reflective surface;

FIG. 1B is a schematic diagram illustrating a reflection shape when a sound wave is reflected from a plane;

FIG. 1C is a schematic diagram illustrating a reflection shape when a sound wave is reflected from a cylindrical curved surface;

FIGS. 2A to 2D are schematic diagrams illustrating a reflection shape when a sound wave is reflected from a conical curved surface;

FIGS. 2E to 2G are schematic diagrams illustrating various arrangements of a conical reflector according to an embodiment of the present disclosure;

FIGS. 3A and 31 are views illustrating various shapes of a conical reflector according to an embodiment of the present disclosure;

FIG. 4A is a view illustrating a conical reflector supported by a support according to an embodiment of the present disclosure;

FIG. 4B is a view illustrating a conical reflector provided as a solid according to an embodiment of the present disclosure;

FIGS. 5A and 5B are views illustrating a conical reflector according to a first embodiment of the present disclosure;

FIGS. 6A and 6B are views illustrating a conical reflector according to a second embodiment of the present disclosure;

FIGS. 7A and 7B are views illustrating a conical reflector according to a third embodiment of the present disclosure;

FIGS. 8A and 8B are views illustrating a conical reflector according to a fourth embodiment of the present disclosure;

FIGS. 9A and 9B are views illustrating a conical reflector according to a fifth embodiment of the present disclosure;

FIGS. 10A and 10B are views illustrating a conical reflector according to a sixth embodiment of the present disclosure;

FIGS. 11A and 11B are views illustrating a conical reflector according to a seventh embodiment of the present disclosure;

FIG. 12 is a view illustrating a conical reflector according to an eighth embodiment of the present disclosure; and

FIG. 13 is a view illustrating a conical reflector according to a ninth embodiment of the present disclosure.

### DETAILED DESCRIPTION

Hereinafter, embodiments of the present disclosure will be described in detail with reference to the accompanying drawings so that they may be easily practiced by those skilled in the art to which the present disclosure pertains. However, the present disclosure may be implemented in various different forms, and is not limited to embodiments described herein. In addition, in the drawings, portions unrelated to the description will be omitted in order to obviously describe the present disclosure, and similar portions will be denoted by similar reference numerals throughout the specification.

Throughout the specification, “including” any component will be understood to imply the inclusion of other components rather than the exclusion of other components unless explicitly described to the contrary.

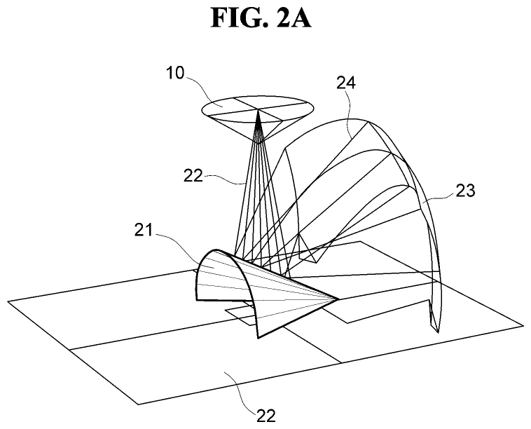

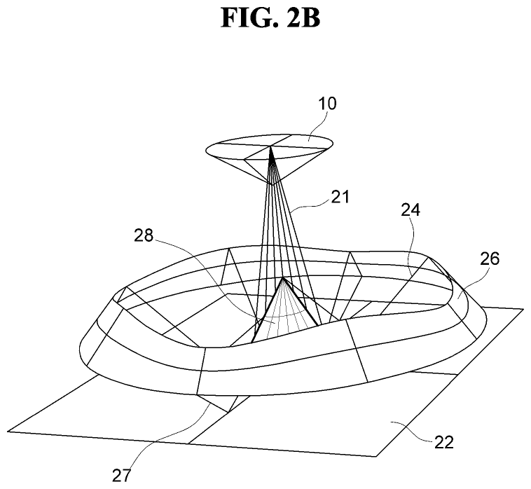

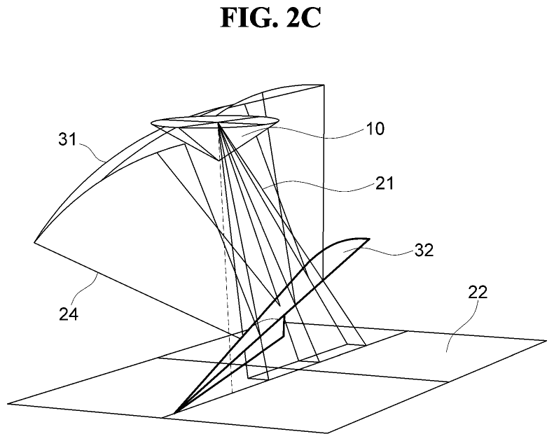

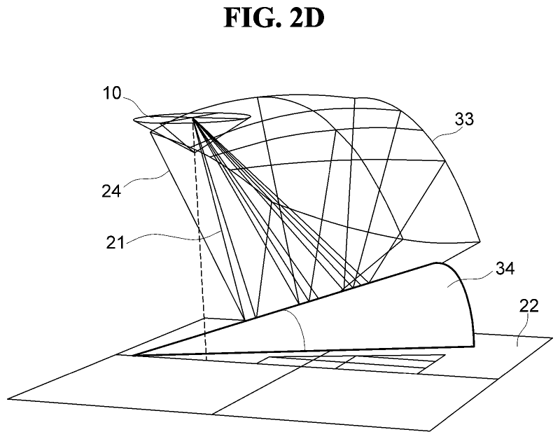

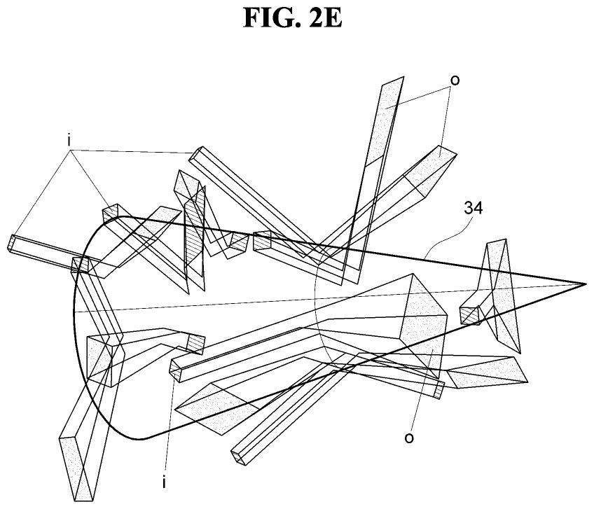

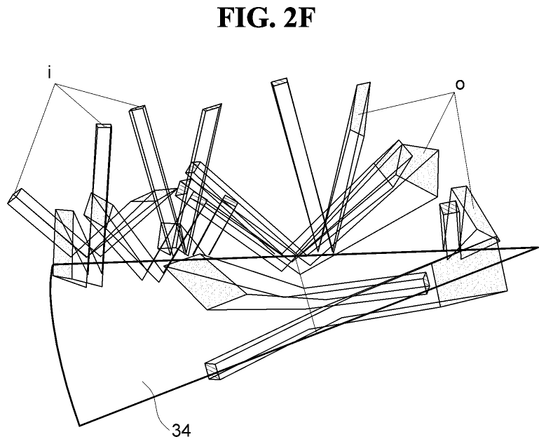

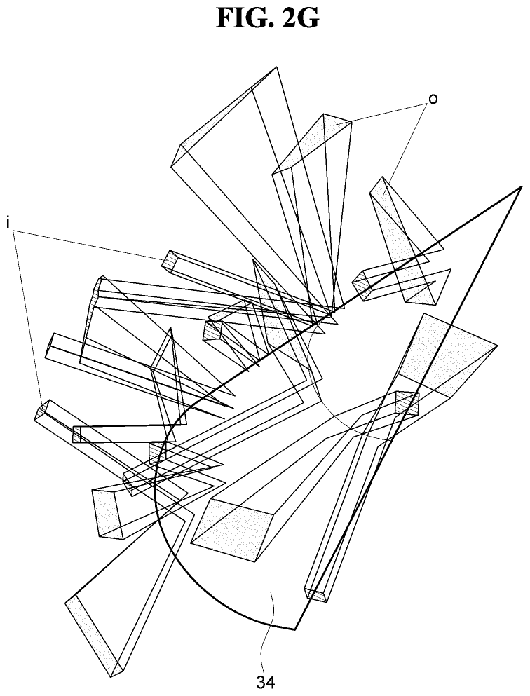

Hereinafter, a cone arranged speaker according to the present disclosure will be described in detail with reference to FIGS. 2A to 13.

Referring to FIGS. 2A to 2D, when a sound wave is reflected from a conical curved surface, a reflection shape may be confirmed.

FIG. 2A shows that a sound wave 21 propagates from the center of the speaker unit 10 to a vertical lower portion and is reflected from a side surface of a conical curved surface 25 when propagating in the speaker unit 10. Referring to FIG. 2A, a reflection surface 23 (a surface generated when sound waves travel the same path) of the sound wave generated by a reflection wave 24 is formed in a shape obtained by deforming a hang glider into a rhombus shape but is formed as a non-uniform curved surface.

FIG. 2B shows that the sound wave 21 propagates in the speaker unit 10 while the sound wave 21 propagates from the center of the speaker unit 10 to the vertical lower portion and is reflected from an upper portion of a conical curved surface 28 arranged so that a planar portion is at a lower portion, a vertex is at an upper portion, and a central axis is vertical. Referring to FIG. 2B, a reflection surface 26 of the sound wave generated by the reflection wave 24 is formed in a shape such as a waistband.

FIG. 2C shows that the sound wave 21 propagates in the speaker unit 10 while the sound wave 21 propagates from the center of the speaker unit 10 to one side rather than the vertical lower portion and is reflected from a part of a side surface of a conical curved surface 32. Referring to FIG. 2C, a reflection surface 31 of the sound wave generated by the reflection wave 24 is formed as a non-uniform curved surface with many curvatures.

FIG. 2D shows that the sound wave 21 propagates in the speaker unit 10 while the sound wave 21 propagates from the center of the speaker unit 10 to one side rather than the vertical lower portion and is reflected from a conical curved surface 34. Referring to FIG. 2D, a reflection surface 33 of the sound wave generated by the reflection wave 24 is formed as a non-uniform and wide curved surface.

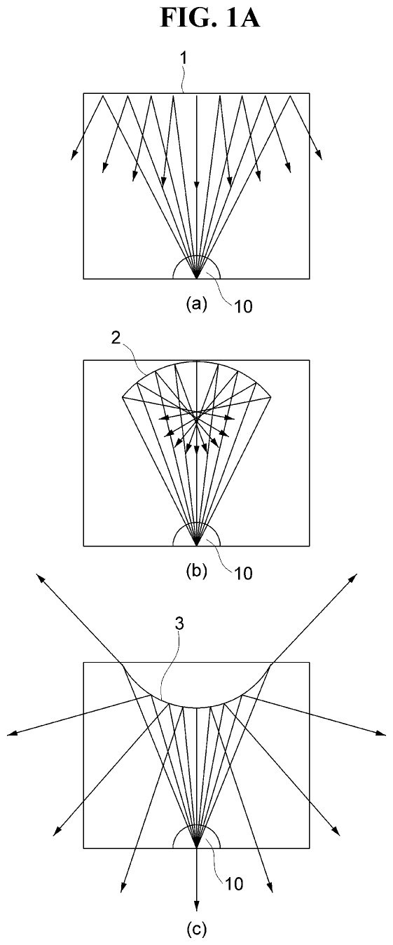

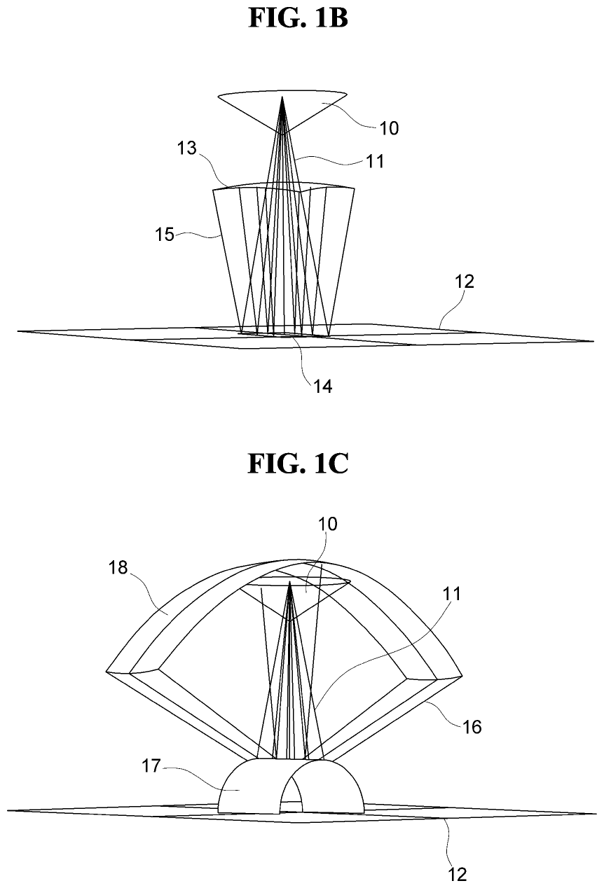

It may be seen through FIGS. 2A to 2D that when the sound wave is reflected from the conical curved surface, unlike the planar reflection or the reflection from the cylindrical curved surface in FIGS. 1A to 1C, the sound wave is reflected in a direction where the reflection of the sound wave is diffused at various angles without being concentrated regardless of an entry angle of the sound wave, and the diffusivity of the path of sound is greater than that of the cylindrical curved surface.

FIGS. 2A to 2G show that the conical reflector may be disposed inside an enclosure irrespective of a position and an angle.

That is, a line connecting the vertex of the conical reflector and the center of the planar portion may be basically provided at an angle of 90 degrees with a central axis of a speaker unit, but may be arranged at various angles other than the angle of 90 degrees with the central axis of the speaker unit.

FIGS. 2E to 2G show a shape of a conical reflector 34 that is cut in half in a longitudinal direction.

FIGS. 2E to 2G show that the conical reflector 34 may be disposed at an unlimited entry angle with respect to the central axis of the speaker unit within the enclosure and has an expanded reflection path of sound without a convergence of path of sound with respect to all entry angles. Here, ‘i’ denotes a partial portion of the center of an entry path of sound of the speaker unit, and ‘o’ denotes a reflection path of sound. The magnitude of the reflection path of sound is relatively increasing compared to all entry path of soundes, which is to shape the diffuse reflection of the path of sound.

The cone arranged speaker according to the present disclosure has such a conical curved surface arranged therein.

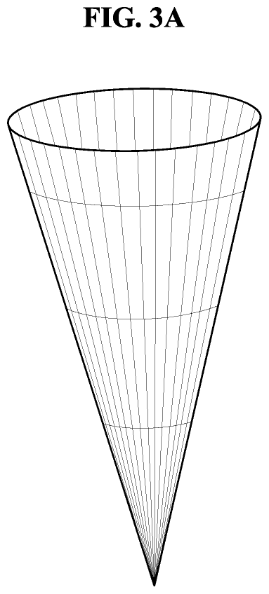

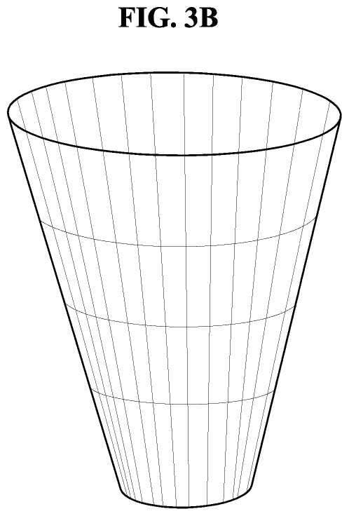

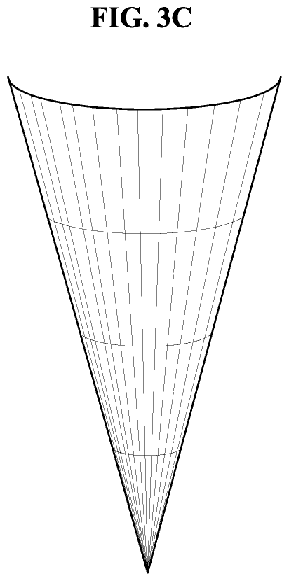

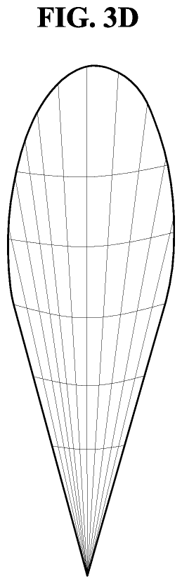

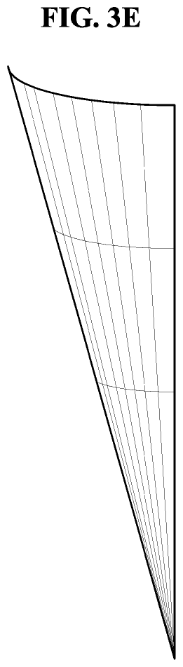

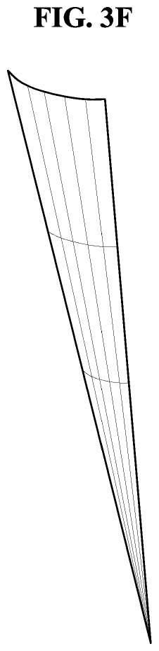

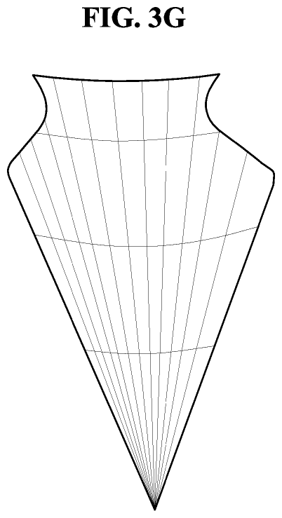

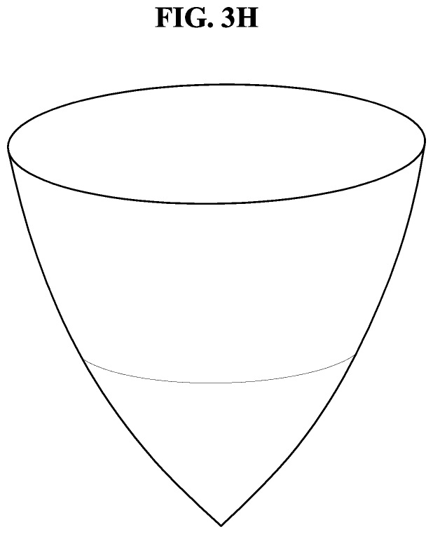

Hereinafter, the conical curved surface according to various embodiments of the present disclosure will be described in detail with reference to FIGS. 3A to 13.

The cone arranged speaker according to the present disclosure includes an enclosure, a speaker unit, and a conical reflector.

The enclosure may be provided in a hexahedral shape, a conical shape, a cylindrical shape, a tunnel shape, an oval shape, etc. as a main body of the speaker, and the shape of the enclosure of the cone arranged speaker according to the present disclosure is not limited to the illustrated shape.

The enclosure of the speaker according to an embodiment of the present disclosure is set as a hexahedron for convenience of description. The enclosure includes a front surface portion 111, a rear surface portion 113 that is a surface opposite to the front surface portion, an upper surface portion 116, a lower surface portion 115 opposite the upper surface portion, a left side surface portion 114 arranged left when viewed from the front of the front surface portion 111, and a right side surface portion 112 opposite to the left side surface portion. In the present embodiment, the shape of the enclosure is set as a hexahedron, but the shape of the enclosure is not limited thereto.

At least one speaker unit 120 may be provided in the enclosure, but for convenience of description, the speaker unit 120 is arranged on the front surface portion 111 as an example.

A conical reflector is provided inside the enclosure and the conical reflector may function as a part of the enclosure.

Referring to FIGS. 3A to 31, the conical reflector according to an embodiment of the present disclosure may be formed in various shapes.

As shown in FIG. 3A, the conical reflector may be provided as a general cone, and as shown in FIG. 3B, a part of an upper portion may be cut or a lower portion may be cut. Also, the conical reflector may be provided as a semi-cone as shown in FIG. 3C, and an upper or lower portion of the semi-cone may be cut diagonally or curvedly as shown in FIGS. 3D and 3G.

In addition, as shown in FIGS. 3E and 3F, the conical reflector may be provided as a 4-split cone and a 6-split cone, a side surface portion may be provided to be convex as shown in FIG. 3H, and the side surface portion may be provided to be concave as shown in FIG. 3I.

Also, although not shown, the conical reflector may be arranged so that the vertex and the center of the planar portion are spaced apart from each other when viewed in a plan view.

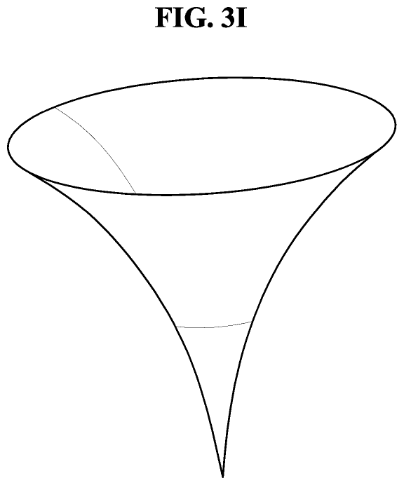

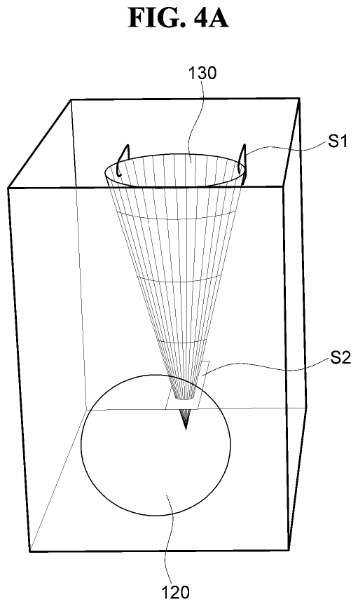

The conical reflector may be arranged on any one surface of the enclosure, or spaced apart from an inner surface of the enclosure without spanning any one surface and supported by supports S1 and S2 as shown in FIG. 4A to be provided inside the enclosure.

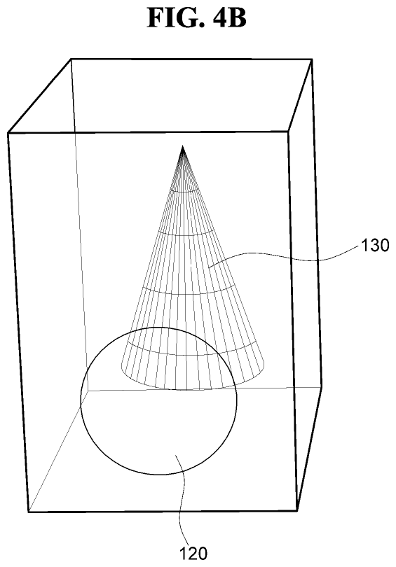

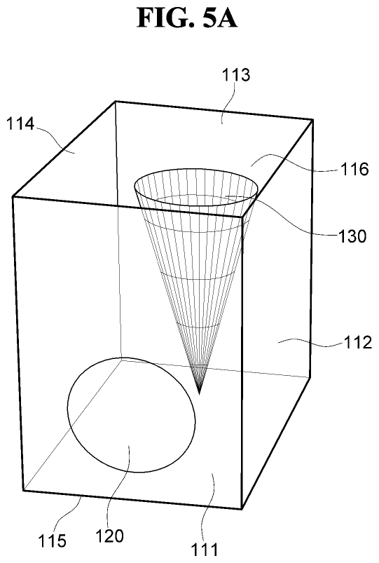

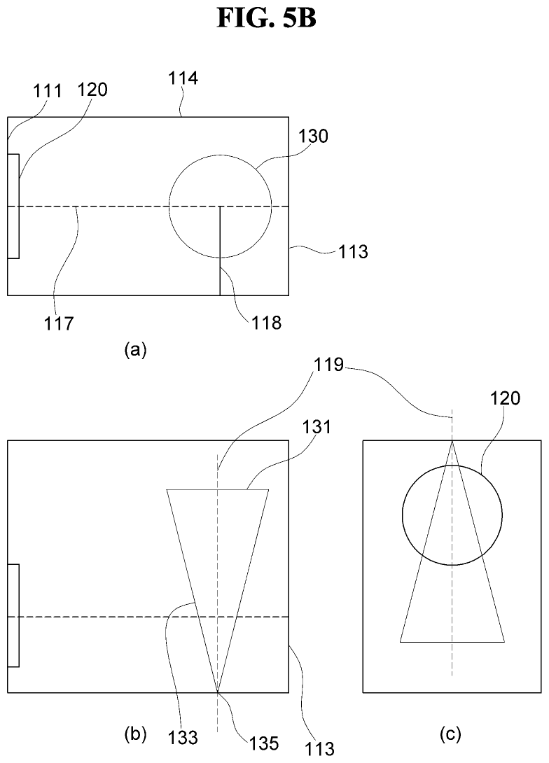

The conical reflector is provided as a cone. Representatively, referring to FIGS. 5A and 5B, the conical reflector 130 is provided as the cone to surface-reflect the sound wave propagating from the speaker unit 120, and is configured as a vertex 135, a circular planar portion 131, and a side surface portion 133 connecting the vertex 135 and the planar portion 131.

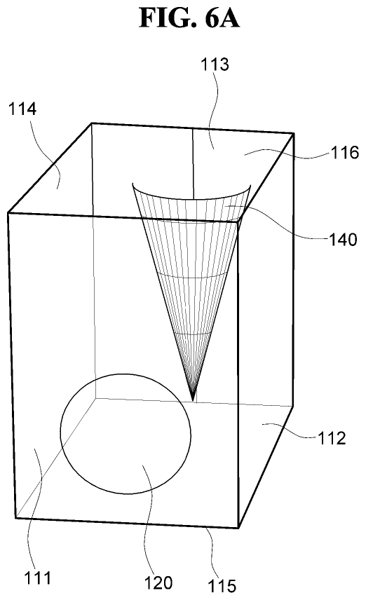

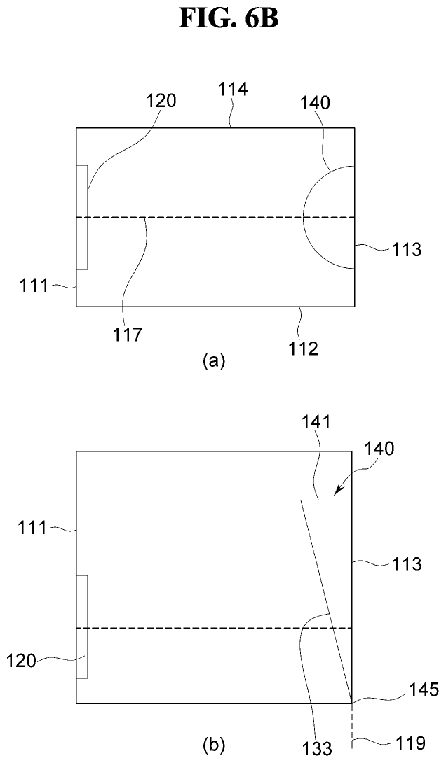

When the conical reflector is provided as a semi-cone as shown in FIGS. 6A and 6B, the planar portion 141 may be provided as a semi-circle.

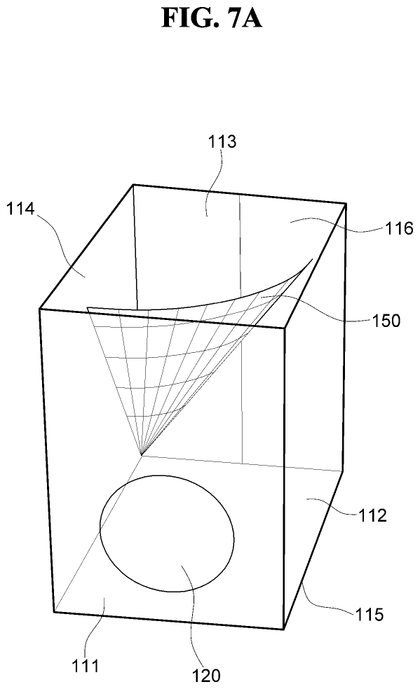

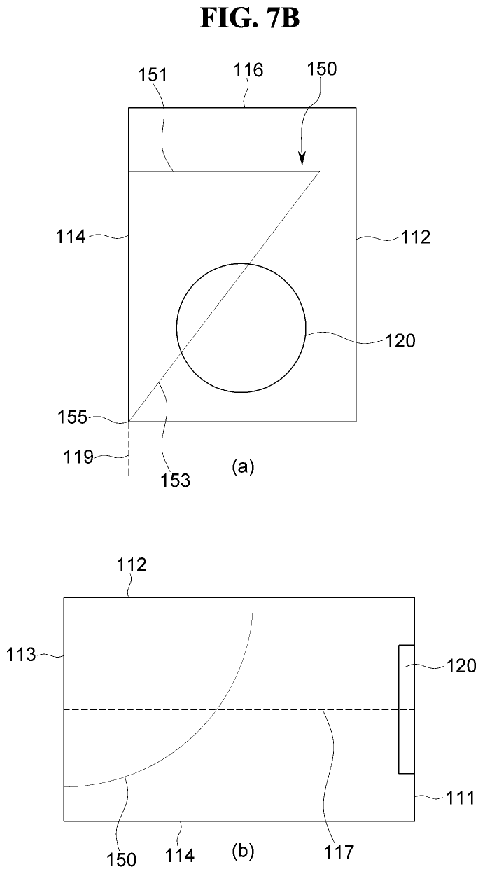

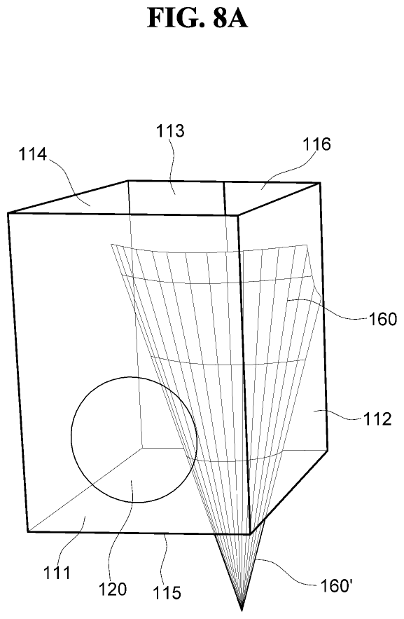

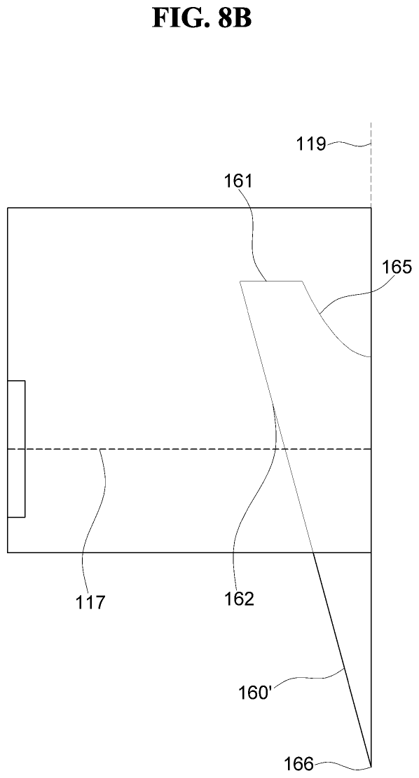

In addition, when the conical reflector is provided as a ¼ cone as shown in FIGS. 7A and 7B, the planar portion 151 may be provided as a ¼ circle, and the conical reflector may be provided in a shape in which a part of the planar portion 161 and a part of the side portion 162 are cut as in FIGS. 8A and 8B.

For convenience of description, upon describing the conical reflector 130 of FIGS. 5A and 5B as an example, a diameter of the planar portion 131 of the conical reflector 130 is provided to be equal to or greater than ½ of a diameter of the speaker unit 120, a height of the conical reflector 130 is formed to be equal to or greater than ⅔ of the diameter of the speaker unit 120, and an angle between the side surface portion 133 and a conical shaft 119 connecting the planar portion 131 and the vertex 135 may be provided to be equal to or greater than 6 degrees.

The conical reflector 130 may be provided so that there is no planar portion 131. Here, ‘there is no planar portion 131’ means a state in which the inside of the conical reflector 130 is empty and simultaneously the planar portion 131 is also provided in an empty circle, that is, a virtual circle, so that sound waves may enter into the inside of the conical reflector 130.

However, the conical reflector 130 may be provided as a hollow closed type or, as shown in FIG. 4B, may be provided as a solid that is filled inside so that the inside thereof may not be used as an expansion space of sound waves.

Here, the hollow closed type means that the conical reflector 130 is provided as a cone but is empty inside, and accordingly, the sound wave propagating from the speaker unit 120 does not propagate to the inside of the conical reflector 130 but is reflected from the outer surface of the conical reflector 130. In addition, the solid means that the inside of the conical reflector 130 is filled, and accordingly, the sound wave propagating from the speaker unit 120 does not propagate to the inside of the conical reflector 130 but may be reflected from the outer surface of the conical reflector 130.

Referring to FIGS. 5A and 5B, the central axis 119 of the conical reflector 130 according to the first embodiment of the present disclosure may be parallel to vertical and longitudinal directions of the enclosure, the planar portion 131 may be provided to be adjacent to the upper surface portion 116 of the enclosure, and the vertex 135 may be provided to be adjacent to or in contact with the lower surface portion 115.

The conical reflector 130 may be provided in the longitudinal direction of the enclosure provided as a rectangular parallelepiped, and the side surface portion 133 thereof may be provided so as not to be in contact with any one surface of the enclosure, but the side surface portion 133 may be provided so as to be in direct contact with any one surface of the enclosure.

Preferably, when a virtual line 117 is drawn in a direction of the rear surface portion 113 which is a surface opposite from the center of the speaker unit 120 of the front surface portion 111 in which the speaker unit 120 is provided, the virtual line 117 and the central axis 119 may be provided to meet. However, it is also possible that the virtual line 117 and the central axis 119 do not meet and the conical reflector 130 is arranged to be adjacent to the left side surface portion 114 or the right side surface portion 112.

Referring to FIGS. 6A and 6B, a conical reflector 140 according to the second embodiment of the present disclosure may be provided as a semi-cone. Here, the semi-cone means that a planar portion 141 is formed as a semi-circle in which half of the conical reflector as shown in FIG. 5A is cut, and a side surface portion 143 is also formed in a shape corresponding to half of the side surface portion 133. A curvature of the conical reflector 140 provided as the semi-cone may be provided to be the same as a curvature of the conical reflector 130 provided as a cone, but may be provided to be smaller.

The central axis 119 of the conical reflector 140 may be provided to be in contact with the rear surface portion 113.

The central axis of the conical reflector 140 may be provided on the rear surface portion 113 opposite to the front surface portion 111 on which the speaker unit 120 is provided, and the planar portion 141 provided as the semi-circle may be provided to be adjacent to the upper surface portion 116 of the enclosure, and the vertex 145 may be provided on the rear surface portion 113 which is the opposite surface and simultaneously may be provided to be adjacent to or in contact with the lower surface portion 115.

The side surface portion 143 may be arranged to face the speaker unit 120.

Even in the second embodiment of the present disclosure, the virtual line 117 and the central axis 119 may be provided to meet, but it is also possible that the conical reflector 140 is arranged to be adjacent to the left side surface portion 114 or the right side surface portion 112 without meeting.

Referring to FIGS. 7A and 7B, the conical reflector 140 according to the third embodiment of the present disclosure may be provided as a ¼ cone. Here, the ¼ cone means that a planar portion 151 is formed as a ¼ cone in a shape in which ¾ of the conical reflector as shown in FIG. 5A is cut, and a side surface portion 153 is also formed in a shape corresponding to ¼ of the side surface portion 133.

The central axis 119 of the conical reflector 150 may be provided at a corner between the rear surface 113 which is a surface opposite to the front surface portion 111 on which the speaker unit 120 is provided, and the left surface portion 114 or the right surface portion 112, and the vertex 155 may be provided at the corner and simultaneously may be provided to be adjacent to or in contact with the lower surface portion 115.

In this case, when the virtual line 117 is drawn in the direction of the rear surface portion 113 which is the opposite surface from the center of the speaker unit 120 of the front surface portion 111 in which the speaker unit 120 is provided, the virtual line 117 and the central axis 119 are provided not to meet.

Referring to FIGS. 8A and 8B, a conical reflector 160 according to the fourth embodiment of the present disclosure has a shape of a cone 160′ in which a part between a vertex 166 and a planar portion 161 is truncated, and the central axis 119 is provided on the rear surface portion 113 which is a surface opposite to the front surface portion 111 on which the speaker unit 120 is provided.

The planar portion 161 of the conical reflector 160 according to the fourth embodiment of the present disclosure may be formed as a ½ circle or in a shape in which a part of the ½ circle is cut, and the central axis 119 may be provided on a surface opposite to the front surface portion 111 on which the speaker unit 120 is provided. Both end portions 165 of the planar portion 161 may be provided in a curved shape so as to be in contact with the left side surface portion 114 and the right side surface portion 112.

Two or more conical reflectors may be provided inside the enclosure.

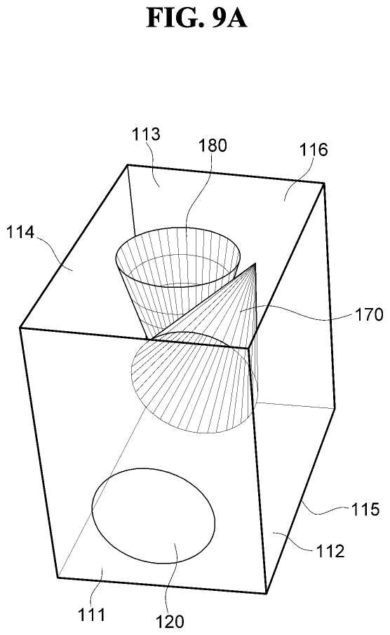

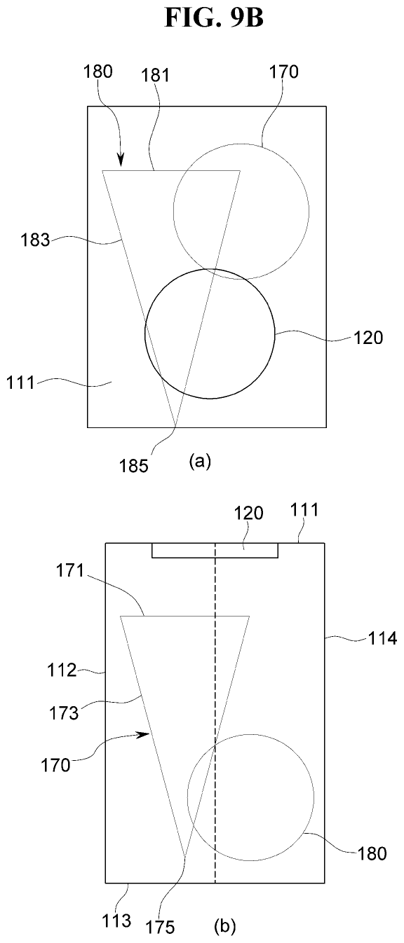

Referring to FIGS. 9A and 9B, conical reflectors 170 and 180 according to the fifth embodiment of the present disclosure may be provided as two cones. The central axes of the two conical reflectors are not parallel to each other, and in the case of FIGS. 9A and 9B, the central axes of the two conical reflectors are provided to be orthogonal to each other.

The conical reflector 170 includes a first vertical reflector 180 and a first horizontal reflector 170, and the conical reflector 170 may be supported by a support that is not shown.

The first vertical reflector 180 may have a central axis parallel to the vertical longitudinal direction of the enclosure, a planar portion 181 may be provided to be adjacent to the upper surface portion 116 of the enclosure, and a vertex 185 may be provided to be adjacent to or in contact with the lower surface portion 115.

The first horizontal reflector 170 may have a central axis parallel to a normal line connecting the front surface portion 111 on which the speaker unit 120 is provided and the rear surface portion 113 opposite to the front surface portion 111, a planar portion 171 may be provided to be adjacent to the front surface portion 111 on which the speaker unit 120 is provided, and a vertex 175 may be provided to be adjacent to or in contact with the rear surface portion 113 which is the opposite surface.

According to the fifth embodiment of the present disclosure, a side surface portion 183 and a side surface portion 173 of the first vertical reflector 180 and the first horizontal reflector 170 may be provided to be in contact with each other, and when a virtual line is drawn in the direction of the opposite surface from the center of the speaker unit 120 of the front surface portion 111 in which the speaker unit 120 is provided, the central axis of the first horizontal reflector 170 may be provided so that the central axis of the first horizontal reflector 170 is not located on the virtual line.

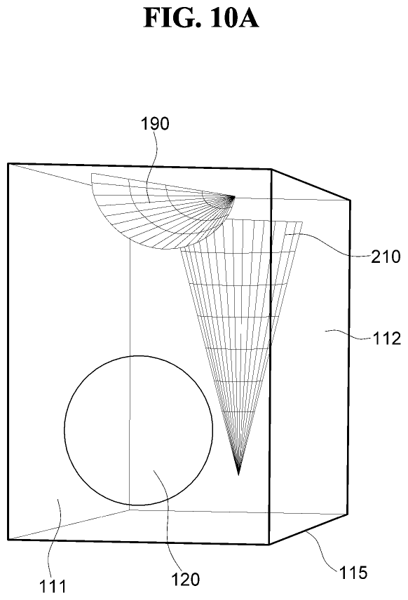

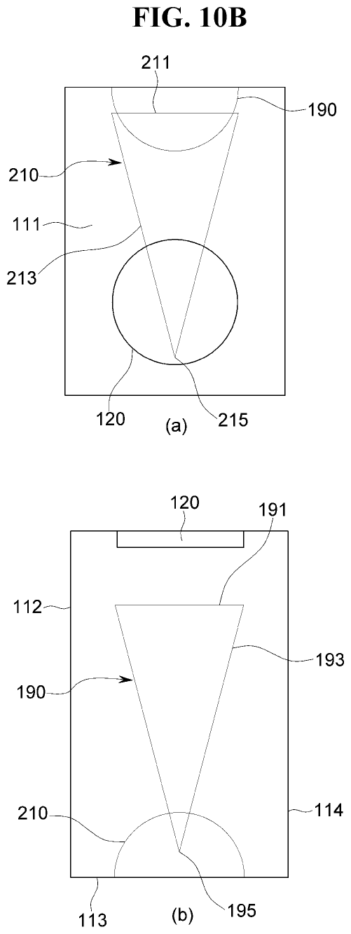

Referring to FIGS. 10A and 10B, conical reflectors 190 and 210 according to the sixth embodiment of the present disclosure may be provided as two cones. Here, the conical reflectors 190 and 210 are provided as semi-cones, and include a second vertical reflector 210 and a second horizontal reflector 190. The central axes of the second vertical reflector 210 and the second horizontal reflector 190 are provided to be orthogonal to each other.

The second vertical reflector 210 may have a central axis on the rear surface portion 113 which is an opposite surface to the front surface portion 111 on which the speaker unit 120 is provided, a planar portion 211 provided as a semi-circle may be provided to be adjacent to the upper surface portion 116 of the enclosure, and a vertex 215 may be provided on the rear surface portion 113 which is the opposite surface and simultaneously may be provided to be adjacent to or in contact with the lower surface portion 115.

The second horizontal reflector 190 may have a central axis provided on the upper surface portion 116, a planar portion 191 provided as a semi-circle may be provided to be adjacent to the front surface portion 111, and a vertex 195 may be provided on the upper surface portion 116 and simultaneously provided to be adjacent to or in contact with the rear surface portion 113 which is the opposite surface.

In this case, when a virtual line is drawn in the direction of the rear surface portion 113 which is the opposite surface from the center of the speaker unit 120 of the front surface portion 111 in which the speaker unit 120 is provided, the center axis of the second vertical reflector 210 and the virtual line may meet, and the central axis of the second horizontal reflector 190 and the virtual line may be arranged parallel to each other.

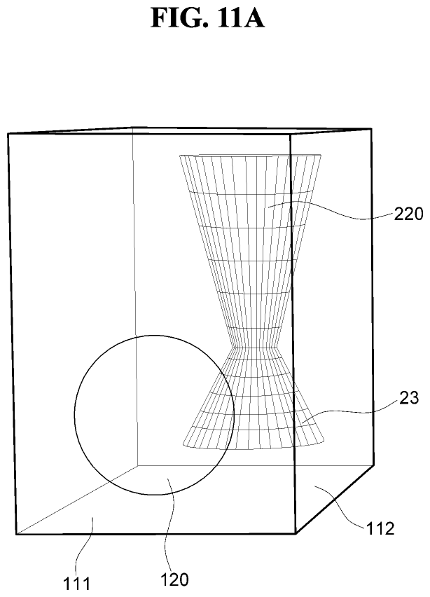

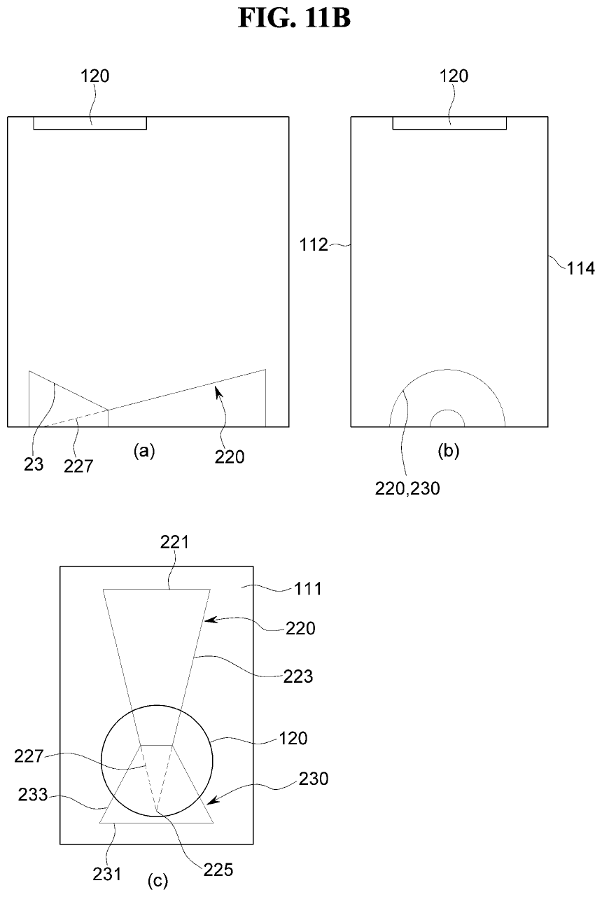

Referring to FIGS. 11A and 11B, conical reflectors 220 and 230 according to the seventh embodiment of the present disclosure are provided as a pair of semi-cones and overlap each other. A part of any one conical reflector 220 may be inserted into the other conical reflector 230 of which a part is truncated and may be combined so that there is no vertex. The conical reflectors 220 and 230 include a third vertical reflector 220 and a fourth vertical reflector 230.

The third vertical reflector 220 has a central axis provided on the rear surface portion 113 which is a surface opposite to the front surface portion 120 on which the speaker unit 120 is provided, the planar portion 221 provided as a semi-circle is provided to be adjacent to the upper surface portion 116 of the enclosure, and the vertex 225 inserted into the inside of the fourth vertical reflector 230 is provided on the rear surface portion 113 which is the opposite surface and simultaneously provided to be adjacent to or in contact with the lower surface portion 115. Since the vertex 225 is inserted into the fourth vertical reflector 230, the vertex 225 may be omitted.

The fourth vertical reflector 230 may have the same central axis as that of the third vertical reflector, and a planar portion 231 may be provided to be adjacent to the lower surface portion 115 of the enclosure, and a part of an upper portion may be provided to be truncated.

The third vertical reflector 220 and the fourth vertical reflector 230 are arranged to overlap. That is, a part 227 of the third vertical reflector 220 including the vertex 225 may be provided to be inserted into the fourth vertical reflector 230. A side surface portion 223 of the third vertical reflector 220 and a side surface portion 233 of the fourth vertical reflector 230 are provided to be connected at a preset angle.

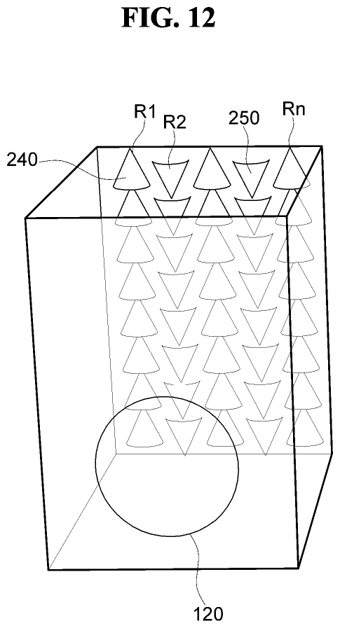

Referring to FIG. 12, a conical reflector according to the eighth embodiment of the present disclosure may be provided as a plurality of sub-reflectors 240 and 250 and a plurality of rows R1, R2, . . . , Rn. The sub-reflectors of the respective rows may be arranged in a certain direction or may be arranged in different directions, may be arranged in the same shape and size, but may be arranged in different shapes and sizes. For example, a first row R1 in which the plurality of sub-reflectors 240 are arranged in the same shape and at the same angle, and a row adjacent to the first row R1 and in which the plurality of sub-reflectors 240 formed in the same shape and angle as those of the first row R1 are arranged may be provided, or a row in which the plurality of sub-reflectors 250 formed in a shape and angle different from those of the first row are arranged may be provided.

Each of the sub-reflectors 240 and 250 in each row may be provided such that a part thereof is inserted into each of the adjacent sub-reflectors 240 and 250, but may be provided to be spaced apart from each other at a preset interval.

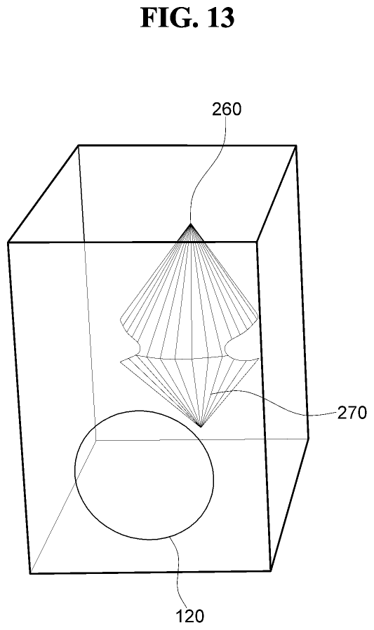

Referring to FIG. 13, in conical reflectors according to the ninth embodiment of the present disclosure, the respective conical reflectors are combined and formed with respect to a planar portion, and the combined conical reflector has a structure partially truncated or spaced apart from the wall surface of the enclosure. For example, the two conical reflectors 260 and 270 may be provided in the same shape and be formed symmetrically with respect to the facing planar portion, and may be provided such that a part of a portion adjacent to the planar portion is truncated. In the present embodiment, the two conical reflectors 260 and 270 may be provided to face each other in front, but it is also possible that the two conical reflectors 260 and 270 are formed to face each other at a preset angle.

According to the present disclosure, a conical reflector is provided as a part of the enclosure so that sound waves arriving directly from the speaker unit or secondary and tertiary reflected arrival waves reflected from the wall surface of the enclosure are diffusely reflected at various angles regardless of the angle of entry of the sound, and thus the resonant frequency of the sound is suppressed and the sound quality of the speaker is enhanced.

The description of the present disclosure provided above is illustrative, and it is to be understood by those skilled in the art that various modifications and alterations may be made without departing from the spirit or essential feature of the present disclosure. Therefore, it is to be understood that the embodiments described above are illustrative rather than being restrictive in all aspects. For example, respective components described as a single form may be implemented in a distributed manner, and similarly, components described as being distributed may also be implemented in a combined form.

It is to be understood that the scope of the present disclosure will be defined by the claims rather than the description described above and all modifications and alterations derived from the claims and their equivalents fall within the scope of the present disclosure.

What is claimed is:

1. A cone arranged speaker comprising:
a speaker unit;
an enclosure accommodating the speaker unit in at least one surface and having an empty space therein; and
a conical reflector formed as a cone inside the enclosure, provided to surface-reflect a sound wave propagating from the speaker unit, including a vertex, a circular planar portion, and a side surface portion connecting the vertex and the planar portion, and provided as at least one conical reflector.

2. The cone arranged speaker of claim 1, wherein the conical reflector is provided as a hollow open type or is provided as a solid inside so that the inside thereof is not used as an expansion space of a sound wave.

3. The cone arranged speaker of claim 1, wherein the conical reflector is arranged on any one surface of the enclosure, or is spaced apart from an inner surface of the enclosure without spanning any one surface and is supported by a support to be provided inside the enclosure.

4. The cone arranged speaker of claim 1, wherein a line connecting the vertex of the conical reflector and the center of the planar portion is arranged at an angle that does not correspond to a longitudinal direction of the enclosure.

5. The cone arranged speaker of claim 1, wherein the conical reflector is provided as a semi-cone.

6. The cone arranged speaker of claim 1, wherein the conical reflector is provided as a ¼ semi-cone, a ⅙ semi-cone, or a ⅛ semi-cone.

7. The cone arranged speaker of claim 1, wherein a part of the conical reflector is truncated.

8. The cone arranged speaker of claim 1, wherein central axes of conical reflectors are provided not to be parallel to each other.

9. The cone arranged speaker of claim 1, wherein a part of any one of the conical reflectors overlaps with the other conical reflector of which a part is truncated.

10. The cone arranged speaker of claim 1, wherein the conical reflector is provided in rows each including a plurality of sub-reflectors, and
wherein the sub-reflectors of each row are arranged in a certain direction or are arranged in different directions.

11. The cone arranged speaker of claim 1, wherein each conical reflector is combined and formed with respect to a planar portion, and the combined conical reflector has a structure in which a part thereof is cut or spaced apart from a wall surface of the enclosure.

12. The cone arranged speaker of claim 1, wherein the side surface portion is provided to be convex or concave.
